(19) United States
(12) Patent Application Publication
(10) Pub. No.: US 2014/0272311 A1
(43) Pub. Date: Sep. 18, 2014

(54) COMPOSITE SANDWICH PANELS AND METHOD OF FORMING ROUND CORNERS IN COMPOSITE SANDWICH PANELS

(71) Applicant: MILLPORT ASSOCIATES S.A., City of Panama (PA)

(72) Inventor: Ulrich Schwartau, Port d Andratx (ES)

(21) Appl. No.: 13/804,834

(22) Filed: Mar. 14, 2013

(51) Int. Cl. B32B 1/04; B32B 37/02

(52) U.S. Cl. CPC B32B 1/04; B32B 37/02
USPC 428/167; 156/196

(57) ABSTRACT

A method for forming a curved surface in a planar composite sandwich panel, the method including: providing a sandwich panel having a first outer layer and a second outer layer spaced from the first outer layer by a panel core. The first outer layer, the second outer layer and the panel core are substantially planar. The sandwich panel includes a first end, a second end and at least one edge. One or more recesses are formed in the second outer layer and the panel core of the sandwich panel, wherein each of the one or more recesses form a continuous channel between the first end and the second end along a first axis. A bonding material is applied to at least one edge of the sandwich panel. A force is applied to at least a portion of the sandwich panel to impart a curved outer surface in the sandwich panel, wherein the curved outer surface is formed by the first outer layer. The sandwich panel is then secured for a predetermined period of time to maintain the curved outer surface.

### TECHNICAL FIELD OF THE INVENTION

The present invention relates generally to constructing buildings, and more particularly, to forming round corners in composite sandwich panels.

### DESCRIPTION OF THE RELATED ART

There is an increasing global demand for lower-cost buildings such as houses, warehouses and office space. The demand for lower-cost buildings is particularly strong in developing countries where economic resources may be limited and natural resources and raw materials may be scarce. For example, in areas of the Middle East or Africa, conventional building materials such as cement, brick, wood or steel may not be readily available or, if available, may be very expensive. In other areas of the world, poverty may make it too costly for people to build houses or other buildings with conventional materials.

The demand for lower-cost housing also is high in areas afflicted by war or natural disasters, such as hurricanes, tornadoes, floods, and the like. These devastating events often lead to widespread destruction of large numbers of buildings and houses, especially when they occur in densely populated regions. The rebuilding of areas affected by these events can cause substantial strain on the supply chain for raw materials, making them difficult or even impossible to obtain. Furthermore, natural disasters often recur and affect the same areas. If a destroyed building is rebuilt using the same conventional materials, it stands to reason that the building may be destroyed or damaged again during a similar event.

It is generally desirable to increase speed of construction and to minimize construction costs. Prefabricated or preassembled components can streamline production and reduce both the time and the cost of building construction. Prefabricated buildings, however, are made from conventional materials and may be scarce or expensive to obtain. Thus, there exists a need for alternative materials and techniques for constructing buildings that use advanced material technologies to increase the speed of construction and also reduce or lower ownership costs.

### SUMMARY

The present invention provides an alternative to conventional construction materials and techniques. Buildings, such as houses, commercial buildings, warehouses, or other structures can be constructed by composite sandwich panels (also referred to as “sandwich panels”) or “panels”, which have an insulative core and one or more outer layers. The buildings can be constructed by gluing several sandwich panels together, and usually traditional fasteners, such as screws, rivets, nails, etc., are not needed for such connections. Generally, composite sandwich panels offer a greater strength-to-weight ratio than traditional materials that are used by the building industry. The composite sandwich panels are generally as strong as, or stronger than, traditional materials including wood-based and steel-based structural insulation panels, while being lighter in weight. Because they weigh less than traditional building materials, the handling and transport of composite sandwich panels is generally less expensive. The composite sandwich panels also can be used to produce light-weight buildings, such as floating houses or other light-weight structures.

Sandwich panels generally are more elastic or flexible than conventional materials such as concrete, steel or brick and, therefore, monolithic buildings made from sandwich panels are more durable than buildings made from conventional materials. For example, sandwich panels also may be non-flammable, waterproof and very strong and durable, and in some cases able to resist hurricane-force winds (up to 300 Kph (kilometers per hour)). The panels also may be resistant to the detrimental effects of algae, fungicides, water, and osmosis. As a result, buildings constructed from sandwich panels are better able to withstanding earthquakes, floods, tornadoes, hurricanes, fires and other natural disasters than buildings constructed from conventional materials.

Standard sandwich panels generally are planar building elements. In many cases, it may be desirable to impart curved outer surfaces in such sandwich panels for aesthetic and/or functional purposes. For example, it may be desirable to incorporate one or more columns in a monolithic structure. It also may be desirable to incorporate a sandwich panel with a round corner (e.g., a wall and/or roof structure) into a building or other structure. As described below, the round corner may be formed one or more recesses in the sandwich panel. The quantity, size and shape of the recesses may be dependent on a variety of factors including, for example, thickness of the sandwich panel, the thickness of one or more layers of the sandwich panel, the desired radius of the building element, etc. The one or more recesses may be distributed in a predetermined manner to facilitate bending of the sandwich panel along the one or more recesses.

Bonding material may be applied to the recessed areas of the sandwich panel and/or to one or more edges of the sandwich panels. The bonding material may be applied before and/or after force(s) sufficient to impart or otherwise form the desired curved outer surface in the sandwich is applied. The sandwich panel may be secured for a sufficient period of time so that the bonding material may adhere to one or more portions of the sandwich panel to maintain the curved outer surface.

One aspect of the invention relates to a method for forming a curved surface in a planar sandwich panel, the method including: providing a sandwich panel having a first outer layer and a second outer layer spaced from the first outer layer by a panel core, wherein the first outer layer, the second outer layer and the panel core are substantially planar and the sandwich panel includes a first end, a second end and at least one edge; forming one or more recesses in the second outer layer and the panel core of the sandwich panel, wherein each of the one or more recesses form a continuous or substantially continuous channel between the first end and the second end along a first axis; applying a bonding material to the at least one edge of the sandwich panel; applying a force to the sandwich panel to impart a curved outer surface in the sandwich panel, wherein the curved outer surface is formed by the first outer layer; and securing the sandwich panel for a predetermined period of time to maintain the curved outer surface (e.g., a period of time sufficient for the bonding material to maintain the curved outer surface).

Another aspect of the invention relates to the one or more recesses having a predefined size and shape.

Another aspect of the invention relates to at least one of a quantity, size and shape of the one or more recesses is selected based at least on a desired radius for the curved outer surface.

Another aspect of the invention relates to at least one of a quantity, size, shape, and distance between recesses is selected based at least on a thickness associated with the sandwich panel.

Another aspect of the invention relates to each of the recesses having a rectangular cross-section.

Another aspect of the invention relates to each of the recesses having a triangular cross-section.

Another aspect of the invention relates to the sandwich panel including a second edge and the sandwich panel is secured to an associated structure by the first and second edge.

Another aspect of the invention relates to the sandwich panel including a second edge and first edge and second edge of the sandwich panel are secured together to form a column.

One aspect of the invention relates to a sandwich panel having a curved surface, the sandwich panel including: a first outer layer and a second outer layer spaced from the first outer layer by a panel core, wherein the second outer layer and the panel core have one or more recesses formed therein, the recesses form a continuous or substantially continuous channel between a first end and a second end for each of the recesses and the first outer layer has a substantially continuous curved outer surface.

Another aspect of the invention relates to the one or more recesses having a predefined size and shape.

Another aspect of the invention relates to a quantity, size and shape of the one or more recesses is selected based at least on a desired radius for the curved outer surface.

Another aspect of the invention relates to a quantity, size and shape of the one or more recesses is selected based at least on a thickness associated with the sandwich panel.

Another aspect of the invention relates to each of the recesses have a rectangular cross-section.

Another aspect of the invention relates to each of the recesses have a triangular cross-section.

One aspect of the invention relates to a method of forming a sandwich panel having a round corner in a sandwich panel that has a first outer layer and a second outer layer spaced from the first outer layer by a panel core, a first end and a second end, the method including forming one or more recesses in the second outer layer and the panel core of the sandwich panel, wherein each of the one or more recesses form a continuous or substantially continuous channel between the first end and the second end along a first axis; applying a force to the sandwich panel to impart a round corner in the sandwich panel, wherein the round corner is formed by the first outer layer; and securing the sandwich panel to maintain the round corner.

Another aspect of the invention relates to the recesses having a triangular cross-section.

Another aspect of the invention relates to the round corner having an angle greater than or substantially equal to 90 degrees, as measured from a center point on the first end, a center point on the second end and a center point associated with the round corner.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

It should be emphasized that the term “comprises/comprising” when used in this specification is taken to specify the presence of stated features, integers, steps or components but does not preclude the presence or addition of one or more other features, integers, steps, components or groups thereof.

Features that are described and/or illustrated with respect to one embodiment may be used in the same way or in a similar way in one or more other embodiments and/or in combination with, or instead of, the features of the other embodiments.

### BRIEF DESCRIPTION OF THE DRAWINGS

FIGS. 1 and 2 are schematic perspective views and fragmentary perspective views of a composite sandwich panel having a round corner outer surface in accordance with aspects of the present invention.

FIG. 3 is a schematic cross-sectional view of another exemplary composite sandwich panel having a round corner in accordance with aspects of the present invention.

FIG. 4 is an schematic isometric view of an exemplary sandwich panel.

FIGS. 5A and 5B are cross-sectional views of a composite sandwich panel in accordance with aspects of the present invention.

FIGS. 5C and 5D are bottom plan views of exemplary composite sandwich panels in accordance with aspects of the present invention.

FIGS. 5E and 5F are cross-sectional views of a composite sandwich panel in accordance with aspects of the present invention.

FIGS. 6 and 7 are cross-sectional views of composite sandwich panels in accordance with aspects of the present invention.

FIG. 8 is an environmental view of an exemplary monolithic structure built from composite materials.

### DETAILED DESCRIPTION OF EMBODIMENTS

In the detailed description that follows, like components have been given the same reference numerals regardless of whether they are shown in different embodiments of the invention. To illustrate the present invention in a clear and concise manner, the drawings may not necessarily be to scale and certain features may be shown in somewhat schematic form. Certain terminology is used herein to describe the different embodiments of the invention. Such terminology is used only for convenience when referring to the figures. For example, “upward,” “downward,” “above,” or “below” merely describe directions in the configurations shown in the figures. The components can be oriented in any direction and the terminology should therefore be interpreted to include such variations. Furthermore, while described primarily with respect to house construction, it will be appreciated that all of the concepts described herein are applicable to the construction of any type building, such as warehouses, commercial buildings, factories, apartments, etc.

The structures described herein are built with composite materials, such as sandwich panels. As used herein, the phrases “sandwich panel”, “sandwich panels” and “composite panel” mean composite a sandwich panel or sandwich panels. Sandwich panels, which may be formed from synthetic materials, provide a light-weight and less expensive alternative to conventional raw materials, e.g., wood, concrete, metal, etc. Sandwich panels are usually connected or joined together with a high-strength bonding material, such as epoxy or glue, and conventional materials, such as nails and screws, are not usually needed. The result is a strong and durable monolithic (e.g., single unit) structure, as described further below.

Rounded building elements (e.g., columns and curved surfaces) may be fabricated by forming recesses (also referred to herein as “cut-outs”) in one side of the sandwich panel. The panel may then be bent to a defined radius and bonded with and/or adhered to another building element and/or structure. The number and dimensions of the recesses (cut-outs) may be related to one or more dimensions of the sandwich panel and or the desired radius.

Referring to FIGS. 1, 2 and 3, exemplary sandwich panels having curved surfaces are illustrated. Referring to FIG. 1, an exemplary sandwich panel 10 in the form of a column is illustrated. The sandwich panel 10 includes a curved outer surface 12 and one or more recesses 14 formed on an opposing side of the sandwich panel 10 relative to the curved outer surface 12. When in the form of a column, the recesses 14 may form a continuous or substantially channel along the length (L) of the sandwich panel 10. The sandwich panel 10 includes a first end 18 and a second end 20 that may be secured together by a bonding material, discussed below, to form the column.

Referring to FIG. 2, an exemplary sandwich panel 30 in the form of a semicircular column is illustrated. The sandwich panel 30 includes a curved outer surface 32 and one or more recesses 34 formed on an opposing side 36 of the sandwich panel relative to the curved outer surface 32. When in the form of a semicircular column, the recesses 34 may form a continuous or substantially channel along the length (L) of the sandwich panel 30. The sandwich panel includes a first end 38 and a second end 40 that may be secured to an associated structure by a bonding material to form the column and/or to secure the column to the associated structure.

Referring to FIG. 3, an exemplary sandwich panel 50 having a round corner with a radius of about 80 millimeters is illustrated. One of ordinary skill in the art will appreciate that almost any desired radius may be obtained in accordance with aspects of the present invention. The sandwich panel 50 includes a curved outer surface 52 and one or more recesses 54 formed on an opposing side 56 of the sandwich panel relative to the curved outer surface 52. When in the form of a round corner, the recesses 54 may form a continuous or substantially continuous channel along the width of the sandwich panel 50. The sandwich panel 50 includes a first end 58 and a second 60 that may be secured to an associated structure by bonding material, discussed below, to secure the sandwich panel having the round corner to the associated structure.

As discussed above, a sandwich panel having a curved surface (e.g., curved surface 12, 32, and 52 in FIGS. 1-3) may be desirable for aesthetic and/or functional purposes. The curved surfaces may be used to form columns, roof structures, round corner, circular or radial building elements etc.

Referring to FIG. 4, an exemplary sandwich panel 70 is illustrated. As used herein, the phrase “sandwich panel” means a panel having two outer layers 72, 74 separated by a core 76. The outer layers 72, 74 of the sandwich panel 70 are made from a composite material that includes a matrix material and a filler or reinforcement material. Exemplary matrix materials include a resin or mixture of resins, e.g., epoxy resin, polyester resin, vinyl ester resin, natural (or non oil-based) resin or phenolic resin, etc. Exemplary filler or reinforcement materials include fiberglass, glass fabric, carbon fiber, or aramid fiber, etc. Other filler or reinforcement materials include, for example, one or more natural fibers, such as, jute, coco, hemp, or elephant grass, balsa wood, or bamboo.

The outer layers 72, 74 (also referred to as laminates) may be relatively thin with respect to the panel core 76. The outer layers 72, 74 may be several millimeters thick and may, for example, be between about 1 mm (millimeter)-12 mm (millimeters) thick; however, it will be appreciated that the outer layers can be thinner than 1 mm (millimeter) or thicker than 12 mm (millimeters) as may be desired. In one embodiment, the outer layers are about 1-3 mm (millimeters) thick.

It will be appreciated that the outer layers 72, 74 may be made thicker by layering several layers of reinforcement material on top of one another. The thickness of the reinforcement material also may be varied to obtain thicker outer layers 72, 74 with a single layer of reinforcement material. Further, different reinforcement materials may be thicker than others and may be selected based upon the desired thickness of the outer layers.

The panel core 76 separates the outer layers 72, 74 of the sandwich panel 70. The panel core 76 may be formed from a light-weight, insulative material, for example, polyurethane, expanded polystyrene, polystyrene hard foam, Styrofoam® material, phenol foam, a natural foam, for example, foams made from cellulose materials, such as a cellulosic corn-based foam, or a combination of several different materials. Other exemplary panel core materials include honeycomb that can be made of polypropylene, non-flammable impregnated paper or other composite materials. It will be appreciated that these materials insulate the interior of the structure and also reduce the sound or noise transmitted through the panels, e.g., from one outer surface to the other or from an exterior to an interior of a building structure, etc. The panel core 76 may be any desired thickness and may be, for example, 30 mm (millimeters)-100 mm (millimeters) thick; however, it will be appreciated that the core can be thinner than 30 mm (millimeters) or thicker than 100 mm (millimeters) as may be desired. In one embodiment, the core is approximately 40 mm (millimeters) thick.

The outer layers 72, 74 are adhered to the core 76 with the matrix materials, such as the resin mixture. Once cured, the outer layers 72, 74 of the sandwich panel 70 are firmly adhered to both sides of the panel core 76, forming a rigid building element. It will be appreciated that the resin mixture also may include additional agents, such as, for example, flame retardants, mold suppressants, curing agents, hardeners, etc. Coatings may be applied to the outer layers 72, 74, such as, for example, finish coats, paint, ultraviolet (UV) protection, water protection, etc.

The panel core 76 may provide good thermal insulation properties and structural properties. The outer layers 72, 74 may add to those properties of the core and also may protect the panel core 76 from damage. The outer layers 72, 74 also may provide rigidity and support to the sandwich panel 70.

The sandwich panel 70 may include a first edge 78, a second edge 80, a third edge 82 and a fourth edge 84. The sandwich panels may be any shape and size. In one embodiment, the sandwich panels are rectangular in shape and may be several meters, or more, in height and width. The sandwich panels also may be other shapes and sizes. The combination of the panel core 76 and outer layers 72, 74 create sandwich panels with high ultimate strength, which is the maximum stress the panels can withstand, and high tensile strength, which is the maximum amount of tensile stress that the panels can withstand before failure. The compressive strength of the panels is such that the panels may be used as both load bearing and non-load bearing walls. In one embodiment, the panels have a load capacity of at least 50 tons per square meter in the vertical direction (indicated by arrows V in FIG. 4) and 2 tons per square meter in the horizontal direction (indicated by arrows H in FIG. 4). The sandwich panels may have other strength characteristics as will be appreciated in the art.

Internal stiffeners may be integrated into the panel core 76 to increase the overall stiffness of the sandwich panel 70. In one embodiment, the stiffeners are made from materials having the same thermal expansion properties as the materials used to construct the panel, such that the stiffeners expand and contract with the rest of the panel when the panel is heated or cooled.

The stiffeners may be made from the same material used to construct the outer layers of the panel. The stiffeners may be made from composite materials and may be placed perpendicular to the top and bottom of the panels and spaced, for example, at distances of about 15 cm (centimeters), 25 cm, 50 cm, or 100 cm. Alternatively, the stiffeners may be placed at different angles, such as a 45-degree angle with respect to the top and bottom of the panel, or at another angle, as may be desired.

Referring to FIGS. 5A-5E, an exemplary method for forming a curved surface in a planar sandwich panel is illustrated. Referring to FIG. 5A, a generally planar sandwich panel 100 is illustrated in schematic cross-sectional view. As set forth above, the sandwich panel 100 has a first outer layer 102 and a second outer layer 104 spaced from the first outer layer by a panel core 106. The first outer layer 102, the second outer layer 104 and the panel core 106 are substantially planar.

Referring to FIGS. 5B and 5C, one or more recesses 108 are formed in the second outer layer 104 and the panel core 106 of the sandwich panel 100. Each of the one or more recesses 108 may form a continuous channel between one end 110 and an opposing end 112, as illustrated in FIG. 5C. For example, if the recesses 108 are formed at spaced apart locations along the width (W) of the sandwich panel 100, the channels formed by the recesses 108 may extend along the length (L) of the sandwich panel 100 (e.g., from the top end 110 to the bottom end 112 of the sandwich panel 100), as shown in FIG. 5C. Referring to FIG. 5D, if the recesses are formed at spaced apart locations along the length of the sandwich panel 100, the channels formed by the recesses are formed along the width of the sandwich panel 100 (e.g., from one side 114 to the opposing side 116), as shown in FIG. 5D.

The one or more recesses 108 may have any desired shape. For example, the one or more recesses 108 are formed in the sandwich panel 100 during manufacture of the sandwich panel 100 and/or on-site during the use of the sandwich panel in a building construction process. In either case, the one or more recesses 108 generally have a predefined size and shape and/or distance. For example, during the manufacturing processes, the sandwich panels may be molded to include the one or more recesses 108. Alternatively, after the sandwich panel is constructed, a tool (e.g., a saw) may be applied to the sandwich panel to impart the desired size and shape of the recesses in the sandwich panel.

In one embodiment, the number of recesses, the quantity size and the shape of the recesses is selected based at least on a desired radius and/or distance of the curved outer surface. In another embodiment, the size and shape of the one or more recesses is selected based at least on a thickness associated with the sandwich panel. For example, referring to FIG. 6, the number and dimensions of the recesses are related to the radius of the building element. The inner radius (R₂) subtracted from the outside radius (R₁) may have a relationship of about a constant (K) that is multiplied by the number of recesses (n) times the width of the recesses, which may also be referred to herein as cuts (z)). Such relationship is illustrated in equation form as follows:

R₁−R₂=K*n*z (Eq. 1)

The constant (K) may be any desired constant and may be chosen based on one or performance characteristics. The constant (K) may be within the range 0.5 to 5, preferably the range is between 0.5 and 1.5. Applying Equation 1 to a standard sandwich panel 20 with a thickness of 62 millimeter and a rectangular recess (cut-out) width of 5 millimeters, a cut may be made every 30 millimeter to obtain the desired radius, as illustrated in FIG. 6. As shown in FIGS. 5B, 5E, 5F, 6 and 7, the recesses (cut-outs) penetrate one outer layer (e.g., outer layer 104 or outer layer 102), but not both outer layers (outer layers 102 and 104). For example, for a standard sandwich panel, as discussed above with reference to Equation 1, the thickness of the base layer 106 taken at a recess to the outer surface of the outer layer 102 is about 10 millimeters and preferably about 8 millimeters, when the constant (K) is 1.1.

One of ordinary skill in the art will readily appreciate that rounded corners may be formed according to other techniques and is not limited to the relationship described above with respect to Eq. (1). Of importance is preventing degradation in the outer layers that a portion of the rounded corners. For example, it is undesirable to form a rounded corner in a composite sandwich panel that has cracks or microcracks in the outer layers. Likewise, it is undesirable to form a rounded corner that causes separation of one or more outer layers from panel core.

In another example, the recesses may have a triangular shape as illustrated in FIG. 7. A triangular shape may be desirable especially for sandwich panels that are to be bent at an angle and/or have a small radius to form a round corner (e.g., round corner 52), as shown in FIG. 3. For example, the triangular shape may be an isosceles triangle with an angle θ₂ of about 17 degrees, as shown in FIG. 7.

Continuing to refer to FIG. 7, similar to the exemplary sandwich panel 70 described above, the sandwich panel 100 has a first outer layer 102 and a second outer layer 104 spaced apart from each other by a panel core 106. The sandwich panel 100 includes a first end 58 and a second end 60. The round corner 52 is formed between the first end 58 and the second end 60.

Referring to FIG. 3, the round corner 52 may be formed to have any desired angle θ (FIG. 3) and/or curvature. The angle θ may be measured from a center point (CP) of the round corner and the center (CP1) of the first end 58 (also referred to herein as a first axis) and center (CP2) of the second end 60 (also referred to herein as a second axis). As shown in FIG. 3, the round corner 52 may be about 90 degrees. In another embodiment, the round corner 52 may form an obtuse angle θ. In another embodiment, the round corner 52 may form an acute angle θ. The size and shape of the round corner 52 may be any desired angle θ. In one embodiment, angle θ substantially is equal to or greater than about 90 degrees. It is generally undesirable for the angle θ to be substantially less than 90 degrees because of stretching of the outer layers, which may cause surface discontinuities (cracks, microcracks, etc.) or de-lamination of one or more outer layers from the panel core.

Referring back to FIG. 5E, a bonding material 120 may be applied to one or more portions (e.g., recesses, ends, panel core 106, second outer layer 104, edges, etc.) of the sandwich panel 100. The details of the bonding material are set forth below. The bonding material 120 may be applied to any suitable thickness.

Referring to FIG. 5F, a force (F) is applied to one or more portions of the sandwich panel 20 to impart a curved outer surface in the sandwich panel 100. The curved outer surface is formed by a substantially continuous first outer layer 102. The applied force (F) may bend the sandwich panel generally along or at the one or more channels formed by the recesses 108. The force (F) may be applied for a period of time sufficient to secure the sandwich panel 20 to maintain the curved outer surface, as shown in FIGS. 1-3. The period of time may be a predetermined amount of time and may range from seconds to hours depending on the amount and type of bonding material 120 used. The forces F may be applied at any location along the outer layer, as will be appreciated.

The bonding material 120 may be applied to a first edge 18, 38, 58 (as shown in FIGS. 1-3, respectively) and a second edge 20, 40, 60 (as shown in FIGS. 1-3, respectively) of the sandwich panel in order to secure the sandwich panel to an associated structure. In another embodiment, the first edge and the second edge of the sandwich panel may be secured together to form a column, as shown in FIG. 1.

Referring to FIG. 8, an exemplary monolithic structure 150, such as a house, is built from a number of sandwich panels. The house 150 includes four sandwich panels 152, 154, 156, 158 connected together to form a front wall 150f and two sandwich panels 158, 160 connected together to form a side wall 150s. The front wall 150f and side wall 150s are connected to one another by an angled joint 162. The house 150 has another side wall (not shown) and a rear wall (not shown) and a roof structure 164. The roof structure 164 includes at least two sandwich panels 166 and 168. The sandwich panels 166, 168 include a curved outer surface 52 for routing liquid that accumulates on the roof to a drainage area. In addition, one or more sandwich panels in the form of columns 170, 172 may also be secured to the roofing structure 164 for aesthetic purposes and/or functional purposes (e.g., support). The columns 170, 172 may be secured to the roofing structure by bonding material, as described in more detail below.

The bonding material 120 may rigidly hold or secure one or more sandwich panels together and also may span across and seal the interface between sandwich panels to prevent moisture from entering the interface.

The bonding material 120 may be applied in any desirable manner. For example, the bonding material 120 may be applied by injection, spreading, spraying, molding, etc. The bonding material 120 rigidly holds or connects the sandwich panels and also may span across and seal the entranceway to the interface between the sandwich panels. The bonding material 80 may be curved, molded, or formed to create a round corner having a radius. The round corner may distribute forces along one or more building elements. The length of the radius may be about 15 mm (millimeters)-40 mm (millimeters) or longer if the panel is thicker than 40 mm (millimeters). The length of the radius may be selected based upon the thicknesses of the outer layers of the sandwich panels used to form the monolithic structure 150. The desired ratio of the radius R to the thickness of the outer layers may be about seven to one (7:1), or more, e.g., 8:1 or an even larger ratio. For instance, if the outer layers are about 2 mm (millimeters) thick, the radius would be at least about 14 mm (millimeters), and may be thicker, if desired, or adjusted based upon a desired strength or other factor. In another example, the outer layers may be 3 mm (millimeters) thick and the radius R is at least about 21 mm (millimeters) or more.

The bonding material 120 may be any suitable bonding material such as epoxy, epoxy resin, glue, cement, adhesive, adhering material or another bonding material (these terms may be used interchangeably and equivalently herein). In one embodiment, the bonding material 120 is more flexible or bendable than the sandwich panels, and may, for example, be four or five times more flexible than the panels. The flexibility of the bonding material, therefore, reduces the likelihood than the joints of the monolithic structure will break or split, and also transmits loads from one panel to another, across the joint. The bonding material may include filling components, such as, fiberglass or a fiberglass and resin mixture, and may, for example, be microfiber and Aerosil®.

The sandwich panels may be customized by cutting and removing a portion of the panel 152, 154 to form an opening for a window 176. The window opening 176 may be cut to any desired size to accommodate the installation of any size window. Similarly, a portion of the panels 152, 154 may be cut and removed to form an opening or doorway 178. Although the sandwich panels (e.g., 152, 154) of FIG. 8 are shown with window 176 and door 178 cutouts, it will be appreciated that the panel can be customized in any manner desired to meet the specifications of an architectural or design plan. The sandwich panels also may be cut in other designs to accommodate other roof, wall, etc. arrangements. It also will be appreciated that while the windows, door and roof are described as being cut from a solid sandwich panel, the openings may be molded or otherwise formed in the panel.

Although the invention has been shown and described with respect to a certain preferred embodiment or embodiments, it is obvious that equivalent alterations and modifications will occur to others skilled in the art upon the reading and understanding of this specification and the annexed drawings.

What is claimed is:

1. A method for forming a curved surface in a planar sandwich panel, the method comprising:
providing a sandwich panel having a first outer layer and a second outer layer spaced from the first outer layer by a panel core, wherein the first outer layer, the second outer layer and the panel core are substantially planar and the sandwich panel includes a first end, a second end and at least one edge;
forming one or more recesses in the second outer layer and the panel core of the sandwich panel, wherein each of the one or more recesses form a continuous channel between the first end and the second end along a first axis;
applying a bonding material to the at least one edge of the sandwich panel;
applying a force to the sandwich panel to impart a curved outer surface in the sandwich panel, wherein the curved outer surface is formed by the first outer layer; and
securing the sandwich panel to maintain the curved outer surface.

2. The method of claim 1, wherein the one or more recesses have a predefined size and shape.

3. The method of claim 2, wherein at least one of quantity, size, shape, and distance between recesses of the one or more recesses is selected based at least on a desired radius for the curved outer surface.

4. The method of claim 2, wherein at least one of a quantity, size and shape of the one or more recesses is selected based at least on a thickness associated with the sandwich panel.

5. The method of claim 2, wherein each of the recesses have a rectangular cross-section.

6. The method of claim 2, wherein each of the recesses have a triangular cross-section.

7. The method of claim 1, wherein the sandwich panel includes a second edge and the sandwich panel is secured to an associated structure by the first and second edge.

8. The method of claim 1, wherein the sandwich panel includes a second edge and first edge and second edge of the sandwich panel are secured together to form a column.

9. A sandwich panel having a curved surface, the sandwich panel comprising:
a first outer layer and a second outer layer spaced from the first outer layer by a panel core, wherein the second outer layer and the panel core have one or more recesses formed therein, the recesses form a continuous channel between a first end and a second end for each of the recesses and the first outer layer has a substantially continuous curved outer surface.

10. The sandwich panel of claim 9, wherein the one or more recesses have a predefined size and shape.

11. The sandwich panel of claim 10, wherein a quantity, size and shape of the one or more recesses is selected based at least on a desired radius for the curved outer surface.

12. The sandwich panel of claim 10, wherein a quantity, size and shape of the one or more recesses is selected based at least on a thickness associated with the sandwich panel.

13. The sandwich panel of claim 10, wherein each of the recesses has a rectangular cross-section.

14. The sandwich panel of claim 10, wherein each of the recesses has a triangular cross-section.

15. A method of forming a sandwich panel having a round corner, the method comprising:
providing at least one sandwich panel having a first outer layer and a second outer layer spaced from the first outer layer by a panel core, wherein the sandwich panel includes a first end and a second end;
forming one or more recesses in the second outer layer and the panel core of the sandwich panel, wherein each of the one or more recesses form a continuous channel between the first end and the second end along a first axis; and
applying a force to the sandwich panel to impart a round corner in the sandwich panel, wherein the round corner is formed by the first outer layer; and
securing the sandwich panel to maintain the round corner.

16. The method of claim 15, wherein the recesses have a triangular cross-section.

17. The method of claim 15, wherein the round corner has an angle greater than or substantially equal to 90 degrees, as measured from a center point on the first end, a center point on the second end and a center point associated with the round corner.

18. The method of claim 16, wherein the round corner has an angle greater than or substantially equal to 90 degrees, as measured from a center point on the first end, a center point on the second end and a center point associated with the round corner.
